(19) United States
(12) Patent Application Publication
(10) Pub. No.: US 2009/0184538 A1
(43) Pub. Date: Jul. 23, 2009

(54) Auxiliary visor

(76) Inventors: Daivd Myer, Wainwright (CA); Dawna Myer, Wainwright (CA)

Correspondence Address: JAMES RAY & ASSOCIATES, 2640 PITCAIRN ROAD, MONROEVILLE, PA, 15146, US

(21) Appl. No.: 12/313,348

(22) Filed: Nov. 19, 2008

Related U.S. Application Data
(60) Provisional application No. 61/011,886, filed on Jan. 22, 2008.

(51) Int. Cl. B60J 3/00

(52) U.S. Cl. 296/97.6

(57) ABSTRACT

An auxiliary visor for an automobile is provided. Such auxiliary visor includes a shield member. Such shield member is manufactured from a first predetermined material and has a first predetermined size and a first predetermined shape. A first securing mechanism has a first predetermined portion engageable with such shield member and a second predetermined portion engageable with an interior portion of an automobile windshield for releasably securing such shield member to such windshield.

### CROSS REFERENCE TO RELATED APPLICATION

This patent application is related to and claims priority from U.S. Provisional Patent Application Ser. No. 61/011,886 filed Jan. 22, 2008.

### FIELD OF THE INVENTION

The present invention relates, in general, to sun visors and sun shades, more particularly, this invention relates to sun visors and sun shades for automobiles.

### BACKGROUND OF THE INVENTION

Prior to the conception and development of the present invention, sun visors and sun shades, as are generally well known in the prior art, have been used in automobiles but only at specific locations. More particularly, automobiles each generally include two sun visors, one on the passenger side of such automobile and one on the driver side, each visor being positioned closely adjacent such automobile's windshield but covering only a small portion thereof. Such sun visors typically can be raised or lowered to cover such small portion of the top of the windshield in front of the driver or in front of the front passenger depending on the degree of sunlight entering such windshield and affecting a driver's vision. Unfortunately, even when both visors are in a down position to cover a portion of such windshield there is an unprotected area in the middle of the windshield through which blinding rays of light may enter causing annoyance and eye strain to the driver and passenger and creating a safety hazard.

Specifically of interest to the present invention are the following: Lehr, U.S. Pat. No. 5,494,328, discloses a glare shield that fits between the sun visors on an automobile having the top edge secured by clips glued to the windshield, or secured beneath the trim near the roof of the automobile, and having the bottom edge secured by a suction cup.

Tovar, U.S. Pat. No. 5,314,226, discloses a sunshield device for use in a parked vehicle, such device is made of an assemblage of elongated panels hingedly connected such that the assemblage can be accordion folded for storage.

Baldwin, U.S. Pat. No. 5,314,226, discloses an auxiliary sun visor that attaches onto the post of a rearview mirror.

Kohnle, et al, U.S. Pat. No. 6,296,294, discloses a rear view mirror sun visor attachment for attaching to a windshield mounted rear view mirror of a vehicle.

Sheridan, U.S. Design Patent No. D 495,639 discloses the ornamental design for a sunvisor which appears to attach to a rearview mirror of an automobile.

None of the aforementioned devices provide the benefits attendant the present invention.

### SUMMARY OF THE INVENTION

The present invention provides an auxiliary visor for an automobile. Such auxiliary visor includes a shield member. Such shield member is manufactured from a first predetermined material and has a first predetermined size and a first predetermined shape. A first securing means has a first predetermined portion engageable with such shield member and a second predetermined portion engageable with an interior portion of an automobile windshield for releasably securing such shield member to such windshield.

According to another embodiment, an auxiliary visor for an automobile is provided. Such auxiliary visor includes a shield member. Such shield member is manufactured from a first predetermined material and has a first predetermined size and a first predetermined shape. A first support member is operably connected to such shield member at a first predetermined end of such shield member for at least one of supporting such shield member, housing such shield member, partially housing such shield member, and a combination thereof. Such first support member is manufactured from a second predetermined material and has a second predetermined size and a second predetermined shape. A first securing means is operably connected to such first support member and releasably engageable with such windshield for securing such first support member to a windshield of such automobile. A second support member is operably connected to a second predetermined end of such shield member. Such second support member is manufactured from a third predetermined material and has a third predetermined size and a third predetermined shape. A second securing means is operably connected to such second support member and releasably engageable with such windshield for securing such second support member to such windshield.

### OBJECTS OF THE INVENTION

It is, therefore, one of the primary objects of the present invention to provide a sunvisor for an automobile which may be releasably attached to such automobile and which may be particularly useful in shading the area of a windshield between such automobile's primary sun visors.

Another object of the present invention is to provide a vehicle sunshade which may be mounted on a vehicle windshield and which may be extended to an open position to prevent light from entering through a predetermined area of such windshield and which may be retracted to a closed position thereby permitting light to enter through such predetermined area of such windshield.

Still another object of the present invention is to provide a sun shade for shielding a driver of an automobile from blinding rays of sun.

Yet another object of the present invention is to provide a removable visor for use in an automobile and particularly useful for shading the area in between an automobile's two primary sun visors.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a partial perspective front view of the invention according to one embodiment of the invention.

FIG. 2 is a partial perspective rear view of the invention according to one embodiment of the invention in which the first securing means includes suction cups.

FIG. 3 is a partial perspective view of the invention according to one embodiment of the invention in which the invention has been secured to an automobile windshield.

FIG. 4 is a partial perspective front view of the invention according to one embodiment of the invention.

FIG. 5 is a partial perspective rear view of the invention according to one embodiment of the invention in which such first securing means includes suction cups.

FIG. 6 is a partial perspective view of the invention according to one embodiment of the invention in which the device has been secured to an automobile windshield.

FIG. 7 is a partial perspective view of the invention according to one embodiment of the invention in which the shield member in a folded position.

FIG. 8 is a partial perspective rear view of the invention according to one embodiment of the invention in which a hook and loop type securing means may be used to partially secure the device to a windshield of an automobile and to secure such shield member in a folded position.

FIG. 9 is a partial perspective front view of the invention according to one embodiment of the invention in which a hook and loop type securing means may be used to partially secure the device to a windshield of an automobile and to secure such shield member in a folded position.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

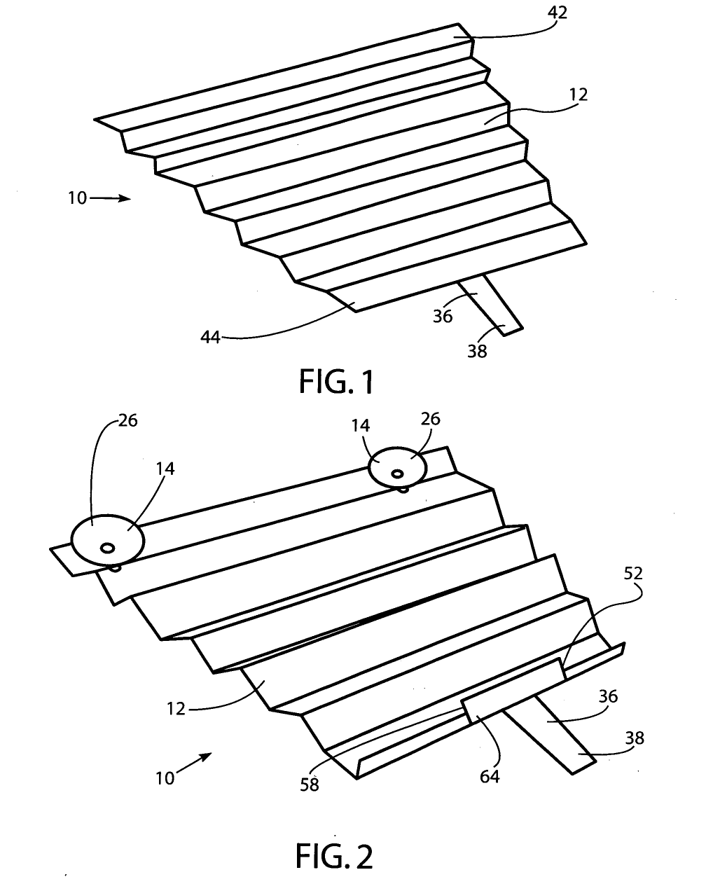

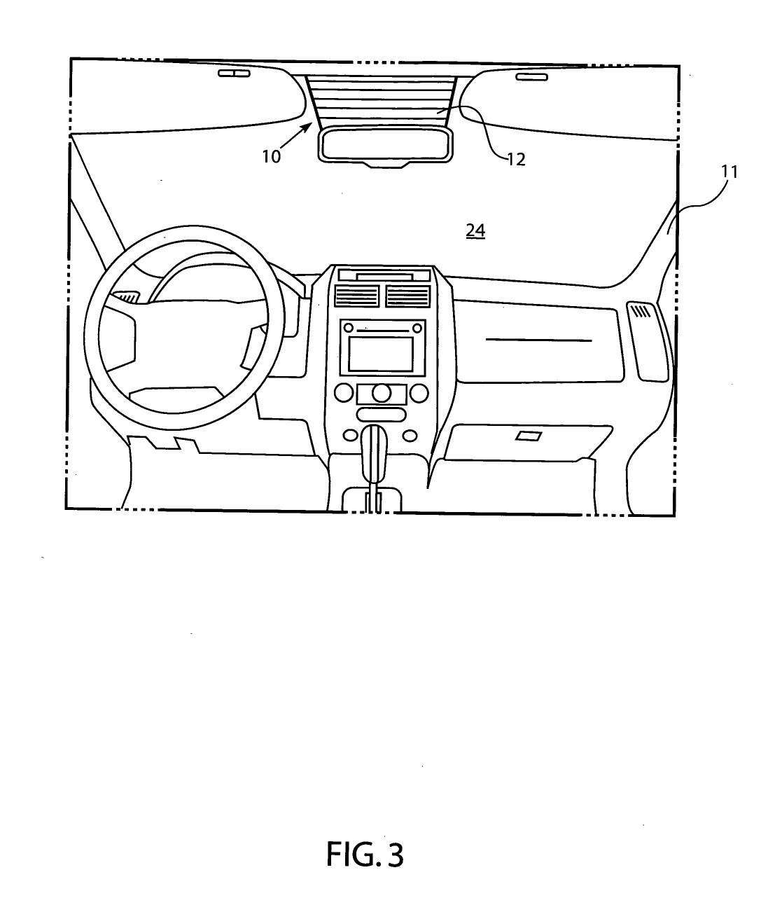

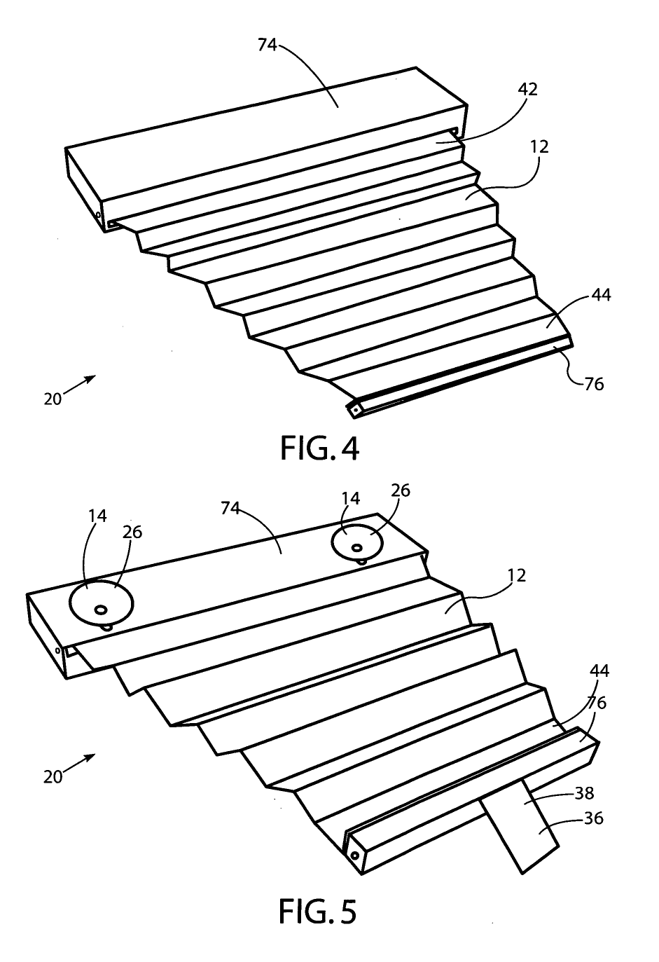

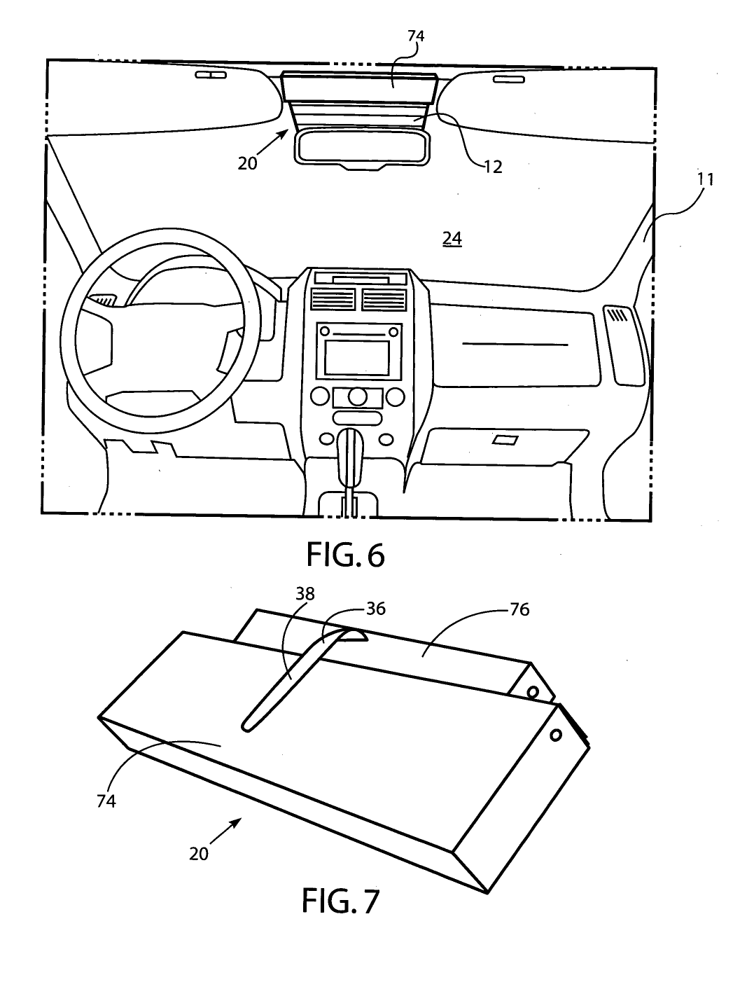

Reference is now made, more particularly, to FIGS. 1-9.

An auxiliary visor, generally designated 10, for an automobile 11 is provided. Such auxiliary visor 10 includes a shield member 12 manufactured from a first predetermined material and having a first predetermined size and a first predetermined shape. It is presently preferred that such first predetermined material is at least one of plastic, fabric, cellulose, and a combination thereof. It is presently preferred that such first predetermined shape is at least one of substantially triangular, substantially rectangular, and substantially circular.

A first securing means 14 has a first predetermined portion engageable with such shield member 12 and a second predetermined portion engageable with an interior portion of an automobile windshield 24 for releasably securing such shield member 12 to such windshield 24. It is presently preferred that such first securing means 14 is at least one suction cup 26. According to another embodiment, such first securing means 14 may be an adhesive type securing means. According to yet another embodiment, such first securing means 14 is a hook and loop type securing means having a first portion thereof disposed on such windshield 24 and a second portion thereof disposed on such shield member 12 and wherein such first portion and such second portion are releasably engageable to each other.

It is presently preferred that such shield member 12 is tapered in width from a first end 42 thereof to a second end 44 thereof.

It is presently preferred that such shield member 12 is at least one of foldable accordion style and rollable and wherein such auxiliary visor 10 further includes a second securing means 36 operably disposed thereon on for releasably securing such shield member 12 in at least one of a folded position and a rolled position. According to one embodiment such second securing means 36 is an adhesive type securing means 38. It is meant that such adhesive type securing means may be used not only to secure such shied member 12 in a compact position but also may be used to secure such second end 44 of such shield member to such windshield 24.

According to another embodiment, such first predetermined portion of such first securing means 14 is engageable with such shield member 12 at such first end 42 thereof and wherein such auxiliary visor 10 further includes a third securing means 52 having a first portion engageable with such shield member 12 at such second end 44 thereof and having a second portion (not shown) engageable with such windshield 24 for operably connecting such tapered second end 44 to such windshield 24. Such third securing means 52 may be at least one suction cup or an adhesive type securing means. However, it is presently preferred that such third securing means 52 is a hook and loop type securing means 58 having a first portion 64 thereof disposed on such shield member 12 and a second portion (not shown) thereof disposed on such windshield 24 and wherein such first portion 64 and such second portion are releasably engageable to each other.

According to yet another embodiment an auxiliary visor, generally designated 20 for an automobile 11 is provided. Such auxiliary visor 20 includes a shield member 12 manufactured from a first predetermined material and having a first predetermined size and a first predetermined shape.

A first support member 74 is operably connected to such shield member 12 at a first predetermined end 42 of such shield member 12 for at least one of supporting such shield member 12, housing such shield member 12, partially housing such shield member 12, and a combination thereof. Such first support member 74 is manufactured from a second predetermined material and has a second predetermined size and a second predetermined shape.

A first securing means 14 is operably connected to such first support member 74 and releasably engageable with such windshield 24 for securing such first support member 74 to a windshield 24 of such automobile 11. It is presently preferred that such first securing means 14 is at least one suction cup 26.

A second support member 76 is operably connected to a second predetermined end 44 of such shield member 12. Such second support member 76 being manufactured from a third predetermined material and having a third predetermined size and a third predetermined shape.

A second securing means 36 is operably connected to such second support member 76 and releasably engageable with such windshield 24 for securing such second support member 76 to such windshield 24.

It is presently preferred that such shield member 12 is at least one of foldable, rollable, and a combination thereof and wherein such second securing means 36 is releasably engageable with such first support member 74 for securing such shield member 12 in at least one of a folded and rolled position as illustrated in FIG. 7.

It is presently preferred that such second securing means is an adhesive type securing means 38.

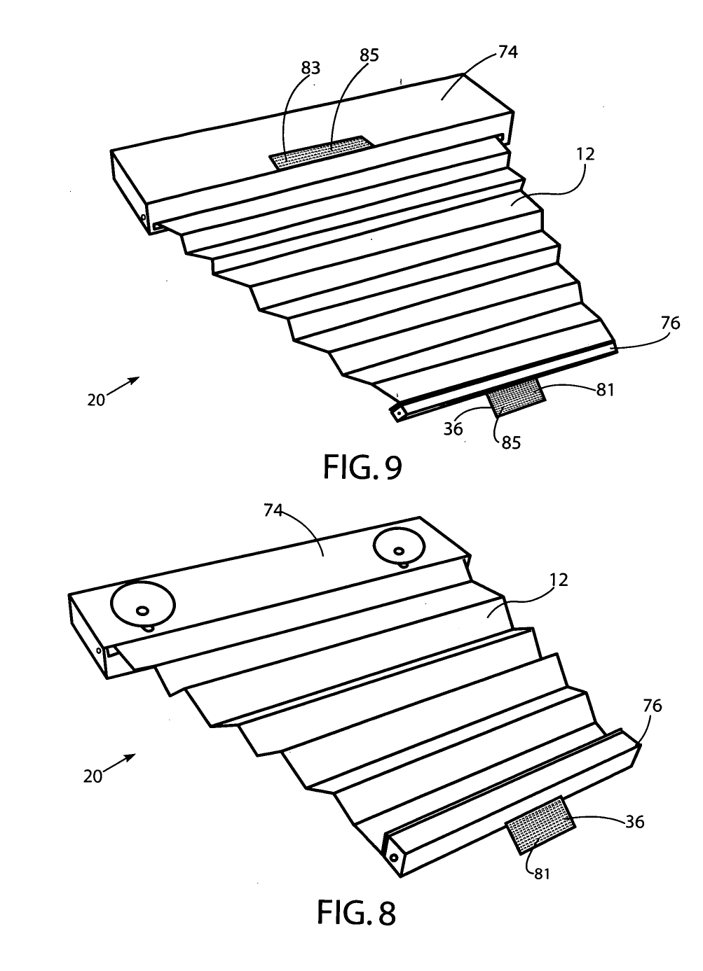

According to yet another embodiment as illustrated in FIG. 8, such second securing means 36 further includes a first portion 81 disposed on such second support member 76 and a second portion (not shown) disposed on such windshield 24, and wherein such first portion 81 and such second portion are releasably engageable with each other. Such securing means may be a hook and loop type securing means. According to still another embodiment, such second securing means 36 includes a first portion 81 disposed on such second support member 76 and a second portion (not shown) disposed on such windshield 24, such first portion and such second portion being releasably engageable with each other, and wherein such second securing means 36 further includes a third portion 83 disposed on such first support member 74, such third portion 83 being releasable engageable with such first portion 81. According to this embodiment it is presently preferred that such second securing means 36 is a hook and loop type securing means 85.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

We claim:

1. An auxiliary visor for an automobile, said auxiliary visor comprising:
a. a shield member, said shield member being manufactured from a first predetermined material and having a first predetermined size and a first predetermined shape; and
b. a first securing means having a first predetermined portion engageable with said shield member and a second predetermined portion engageable with an interior portion of an automobile windshield for releasably securing said shield member to such windshield.

2. An auxiliary visor according to claim 1 wherein said shield member is at least one of foldable accordion style and rollable and wherein said auxiliary visor further includes a second securing means operably disposed thereon on for releasably securing said shield member in at least one of a folded position and a rolled position.

3. An auxiliary visor according to claim 1 wherein said first predetermined material is at least one of plastic, fabric, cellulose, and a combination thereof.

4. An auxiliary visor according to claim 1 wherein said first predetermined shape is at least one of substantially triangular, substantially rectangular, and substantially circular.

5. An auxiliary visor according to claim 1 wherein said shield member is tapered in width from a first end thereof to a second end thereof.

6. An auxiliary visor according to claim 5 wherein said first portion of said first securing means is engageable with said shield member at said first end thereof and wherein said auxiliary visor further includes a third securing means having a first portion engageable with said shield member at said second end thereof and having a second portion engageable with such windshield for operably connecting said tapered second end to said windshield.

7. An auxiliary visor according to claim 1 wherein said first securing means is at least one suction cup.

8. An auxiliary visor according to claim 1 wherein said first securing means is an adhesive securing means.

9. An auxiliary visor according to claim 1 wherein said first securing means is a hook and loop type securing means having a first portion thereof disposed on said shield member and a second portion thereof disposed on said windshield and wherein said first portion and said second portion are releasably engageable to each other.

10. An auxiliary visor according to claim 6 wherein said third securing means is at least one suction cup.

11. An auxiliary visor according to claim 6 wherein said third securing means is an adhesive securing means.

12. An auxiliary visor according to claim 6 wherein said second securing means is an adhesive type securing means.

13. An auxiliary visor according to claim 6 wherein said third securing means is a hook and loop type securing means having a first portion thereof disposed on such windshield and a second portion thereof disposed on said shield member and wherein said first portion and said second portion are releasably engageable to each other.

14. An auxiliary visor for an automobile, said auxiliary visor comprising:
a. a shield member, said shield member being manufactured from a first predetermined material and having a first predetermined size and a first predetermined shape;
b. a first support member operably connected to said shield member at a first predetermined end of said shield member for at least one of supporting said shield member, housing said shield member, partially housing said shield member, and a combination thereof, said first support member being manufactured from a second predetermined material and having a second predetermined size and a second predetermined shape;
c. a first securing means operably connected to said first support member and releasably engageable with such windshield for securing said first support member to a windshield of such automobile;
d. a second support member operably connected to a second predetermined end of said shield member, said second support member being manufactured from a third predetermined material and having a third predetermined size and a third predetermined shape; and
e. a second securing means operably connected to said second support member and releasably engageable with such windshield for securing said second support member to such windshield.

15. An auxiliary visor for an automobile according to claim 14 wherein said shield member is at least one of foldable, rollable, and a combination thereof and wherein said second securing means is releasably engageable with said first support member for securing said shield member in at least one of a folded and rolled position.

16. An auxiliary visor for an automobile according to claim 15 wherein said second securing means is an adhesive type securing means.

17. An auxiliary visor for an automobile according to claim 14 wherein said first securing means is a suction cup type securing means.

18. An auxiliary visor for an automobile according to claim 14 wherein said second securing means further includes a first portion disposed on said second support member and a second portion disposed on said windshield, and wherein said first portion and said second portion are releasably engageable with each other.

19. An auxiliary visor for an automobile according to claim 14 wherein said second securing means further includes a first portion disposed on said second support member and a second portion disposed on said windshield said first portion and said second portion are releasably engageable with each other, and wherein said second securing means further includes a third portion disposed on said first support member, said third portion being releasable engageable with said first portion.

20. An auxiliary visor for an automobile according to claim 19 wherein said second securing means is a hook and loop type securing means.
